(19) United States
(12) Patent Application Publication
(10) Pub. No.: US 2012/0317113 A1
(43) Pub. Date: Dec. 13, 2012

(54) COMPUTING DEVICE, STORAGE MEDIUM, AND METHOD FOR PROCESSING BILL OF MATERIAL OF ELECTRONIC PRODUCTS

(75) Inventors: CHUN-SHENG CHEN, Tu-Cheng (TW); FENG-LONG HE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/449,298

(22) Filed: Apr. 17, 2012

(30) Foreign Application Priority Data
Jun. 7, 2011 (CN) 201110151010.1

(51) Int. Cl. G06F 17/30

(52) U.S. Cl. 707/737; 707/E17.046

(57) ABSTRACT

In a method for processing a bill of material (BOM) of an electronic product using a computing device, each electronic component of the electronic product is identified according to a function description of the electronic component, and an identification code for each of the electronic components is generated. The method creates a functional BOM of the electronic components according to characteristic data of the electronic components, and classifies the electronic components into different groups of the functional BOM according to the identification code of each of the electronic components. The method further counts a total number of the electronic components in each of the classified groups, generates assembly information of the electronic product according to the functional BOM, and displays the assembly information of the electronic product on a display device that is connected to the computing device.

### BACKGROUND

1. Technical Field

Embodiments of the present disclosure relate to systems and methods for processing data using computer systems, and particularly to a computing device, a storage medium, and a method for processing a bill of material (BOM) of electronic products.

2. Description of Related Art

Bill of materials (BOMs) are usually generated during the process of manufacturing electronic products, and used to store a large mount of data, such as characteristic data of electronic components of the manufactured electronic products. Normally, the generated BOMs are not fully fit for a manufacturing requirement of the manufactory. Therefore, operators manually processes the BOMs according to the manufacturing requirement, such as sorting the electronic components according to the characteristic data of electronic components. However, the processing the BOMs is costly and inefficient if done manually. Therefore, there is need a system and method for automatically processing the BOMs according to the manufacturing requirement, to increase the efficiency of the manufacturing.

### BRIEF DESCRIPTION OF THE DRAWINGS

FIG. 1 is a block diagram of one embodiment of a computing device including a BOM processing system.

FIG. 2 is a flowchart of one embodiment of a method for processing a BOM of an electronic product using the computing device of FIG. 1.

FIG. 3 is a schematic table illustrating one example of classifying all electronic components in a BOM of the electronic product.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

In the present disclosure, the word “module,” as used herein, refers to logic embodied in hardware or firmware, or to a collection of software instructions, written in a program language. In one embodiment, the program language may be Java, C, or assembly.

One or more software instructions in the modules may be embedded in firmware, such as an EPROM. The modules described herein may be implemented as either software and/or hardware modules and may be stored in any type of non-transitory computer-readable medium or other storage device. Some non-limiting examples of non-transitory computer-readable medium include CDs, DVDs, flash memory, and hard disk drives.

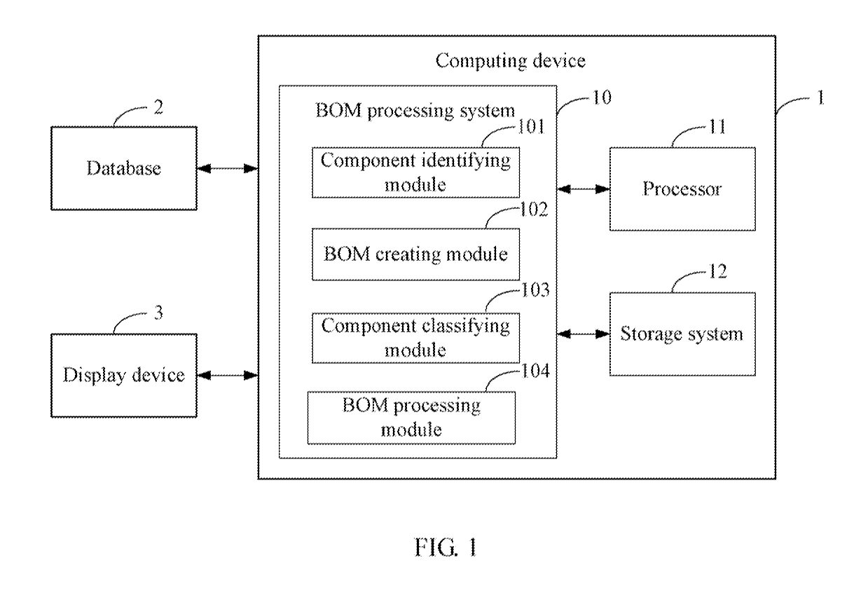

FIG. 1 is a block diagram of one embodiment of a computing device 1 including a bill of material (BOM) processing system 10. In the embodiment, the computing device 1 electronically connects to a database 2 and a display device 3. The computing device 1 may further include at least one processor 11 and a storage system 12. The BOM processing system 10 may include a plurality of functional modules that are stored in the storage system 12 and executed by the at least one processor 11, and automatically processes a BOM of an electronic product according to a design requirement of a manufactory of the electronic product. FIG. 1 is only one example of the computing device 1 that includes more or fewer components than those shown in the embodiment, or have a different configuration of the various components.

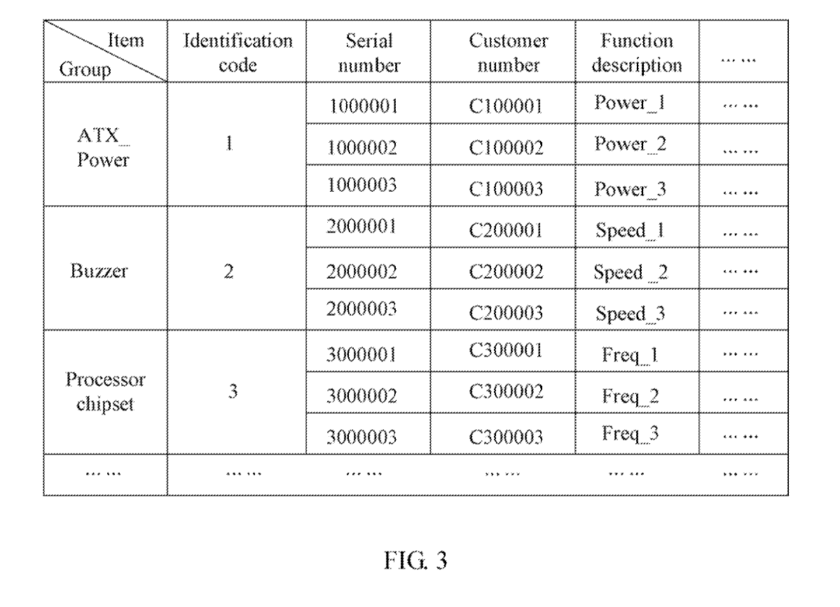

The database 2 stores an original BOM of an electronic product that includes a plurality of characteristic data of electronic components of the electronic product. In one embodiment, the electronic product may be a computer, a game machine, or a household appliance, which includes a plurality of electronic components such as a power supply, a processor chipset, and a buzzer. As shown in FIG. 3, the characteristic data of the electronic components may include a name of each electronic component, a serial number of each electronic component, a customer number of each electronic component, and a function description of each electronic component.

In one embodiment, the BOM processing system 10 includes a component identifying module 101, a BOM creating module 102, a component classifying module 103, and a BOM processing module 104. The modules 101-104 may comprise computerized instructions in the form of one or more programs that are stored in the storage system 12 and executed by the at least one processor 11. In one embodiment, the storage system 12 may be an internal storage system, such as a random access memory (RAM) for the temporary storage of information, and/or a read only memory (ROM) for the permanent storage of information.

In some embodiments, the storage system 12 may also be an external storage system, such as an external hard disk, a storage card, or a data storage medium. A detailed description of each module will be given in the following paragraphs.

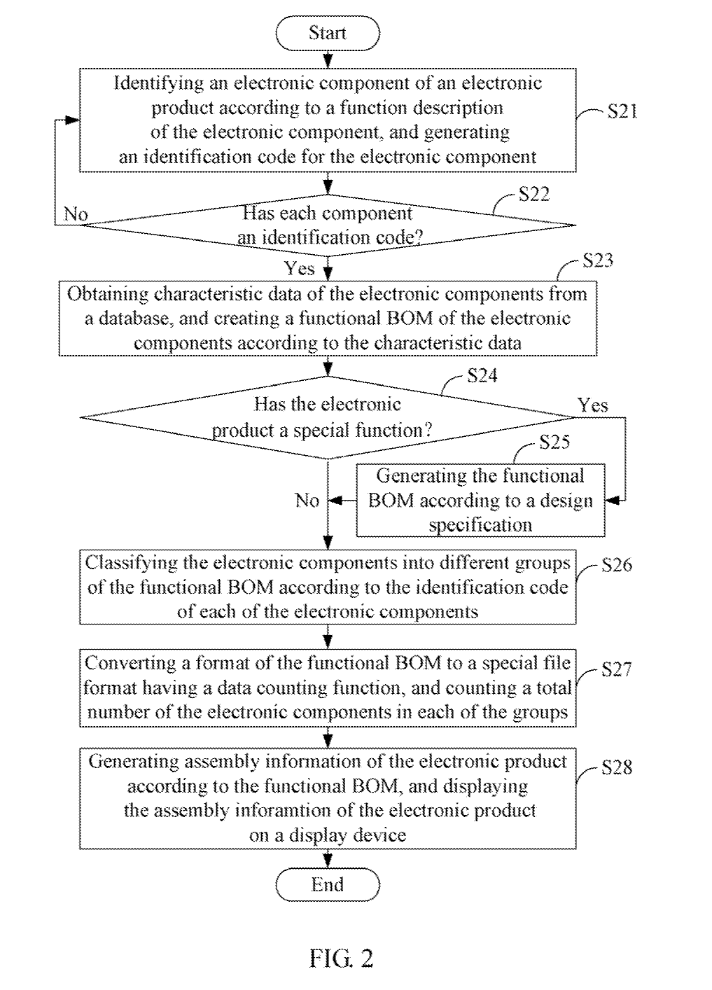

FIG. 2 is a flowchart of one embodiment of a method for processing a BOM of an electronic product using the computing device 1 of FIG. 1. In the embodiment, the method can automatically process the BOM of the electronic product according to a design requirement of the manufactory. Depending on the embodiment, additional blocks may be added, others removed, and the ordering of the blocks may be changed.

In block S21, the component identifying module 101 identifies an electronic component according to a function description of the electronic component, and generates an identification code for the electronic component. Referring to FIG. 3, if a power supply (e.g., ATX_power) has a power function, the component identifying module 101 may generate an identification code “1” for the power supply. If a buzzer has a heat dispersion function, the component identifying module 101 may generate an identification code “2” for the buzzer. If a processor chipset has data processing function, the component identifying module 101 may generate an identification code “3” for the processor chipset.

In block S22, the component identifying module 101 determines whether all the electronic components have been identified. In one embodiment, the component identifying module 101 checks if each of the electronic components has an identification code to determine whether the electronic component has been identified.

In block S23, the BOM creating module 102 obtains characteristic data of the electronic components from the original BOM stored in the database 2, and creates a functional BOM of the electronic components according to the characteristic data of the electronic components. As shown in FIG. 3, the characteristic data of the electronic components may include a name of each electronic component, a serial number of each electronic component, a customer number of each electronic component, and a function description of each electronic component.

In block S24, the BOM creating module 102 determines whether the electronic product has a special function according to a design specification of the electronic product. If the electronic product has a special function, block S25 is implemented. Otherwise, if the electronic product has no special function, block S26 is implemented. In one embodiment, the design specification describes a requirement of special function for the electronic product, and may be provided by the manufactory of the electronic product.

In block S25, the BOM creating module 102 generates a functional BOM of the electronic product according to the design specification. For example, if the design specification specifies a computer having an audio card, the BOM creating module 102 creates a functional BOM including characteristic data of the audio card. If specification specifies a computer without a audio card, the BOM creating module 102 creates a functional BOM having no characteristic data of the audio card.

In block S26, the component classifying module 103 classifies the electronic components into different groups of the functional BOM according to the identification code of each of the electronic components. In one example with respect to FIG. 3, the component classifying module 103 classifies all the power supplies (e.g., ATX_power) having the identification code “1” into a first group (i.e., a power supply group), which includes a first power supply having a serial number “1000001”, a second power supply having a serial number “1000002”, and a third power supply having a serial number “1000003”. The component classifying module 103 classifies all the buzzers having the identification code “2” into a second group (i.e., a buzzer group), which includes a first buzzer having a serial number “2000001”, a second buzzer having a serial number “2000002”, and a third buzzer having a serial number “2000003”. The component classifying module 103 classifies all the processor chipsets having the identification code “3” into a third group (i.e., a processor chipset group), which includes a first processor chipset having a serial number “3000001”, a second processor chipset having a serial number “3000002”, and a third processor chipset having a serial number “3000003”.

In block S27, the BOM processing module 104 converts the format of the functional BOM to a special file format having a data counting function, and counts a total number of the electronic components in each of the classified groups. In one embodiment, the special file format may be an EXCEL format or other file format having the data counting function.

In block S28, the BOM processing module 104 generates assembly information of the electronic product according to the functional BOM, and displays the assembly information of the electronic product on the display device 3. In the embodiment, the assembly information of the electronic product includes the characteristic data of all the electronic components that are stored in the functional BOM. The BOM processing module 104 may store the assembly information of the electronic product and the functional BOM to the storage system 12.

All of the processes described above may be embodied in, and fully automated via, functional code modules executed by one or more general purpose processors of computing devices. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a storage system;
at least one processor; and
one or more programs stored in the storage system and executable by the at least one processor, the one or more programs comprising:
an component identifying module that identifies each electronic component of an electronic product according to a function description of the electronic component, and generates an identification code for each of the electronic components;
a BOM creating module that obtains characteristic data of all the electronic components from a database that is connected to the computing device, and creates a functional bill of material (BOM) of the electronic components according to the characteristic data of the electronic components;
a component classifying module that classifies the electronic components into different groups of the functional BOM according to the identification code of each of the electronic components; and
a BOM processing module that converts a format of the functional BOM to a special file format having a data counting function, counts a total number of the electronic components in each of the classified groups, generates assembly information of the electronic product according to the functional BOM, and displays the assembly information of the electronic product on a display device that is connected to the computing device.

2. The computing device according to claim 1, wherein the component identifying module further determines whether all the electronic components have been identified by checking whether each of the electronic components has an identification code.

3. The computing device according to claim 1, wherein the BOM creating module further determines whether the electronic product has a special function according to a design specification of the electronic product, and generates the functional BOM of the electronic product according to the design specification if the electronic product has the special function.

4. The computing device according to claim 1, wherein the BOM processing module further stores the assembly information of the electronic product and the functional BOM of the electronic product into the storage system.

5. The computing device according to claim 1, wherein the assembly information of the electronic product comprises the characteristic data of the electronic components that are recorded in the functional BOM of the electronic product.

6. The computing device according to claim 1, wherein the characteristic data of the electronic components comprise a name of each electronic component, a serial number of each electronic component, a customer number of each electronic component, and a function description of each electronic component.

7. A computerized method for processing a bill of material (BOM) of an electronic product using a computing device, the method comprising:
identifying each electronic component of the electronic product according to a function description of the electronic component, and generating an identification code for each of the electronic components;
obtaining characteristic data of all the electronic components from a database that is connected to the computing device, and creating a functional BOM of the electronic components according to the characteristic data of the electronic components;
classifying the electronic components into different groups of the functional BOM according to the identification code of each of the electronic components;
converting a format of the functional BOM to a special file format having a data counting function, and counting a total number of the electronic components in each of the classified groups; and
generating assembly information of the electronic product according to the functional BOM, and displaying the assembly information of the electronic product on a display device that is connected to the computing device.

8. The method according to claim 7, further comprising:
determining whether all the electronic components have been identified by checking whether each of the electronic components has an identification code.

9. The method according to claim 7, further comprising:
determining whether the electronic product has a special function according to a design specification of the electronic product; and
generating the functional BOM of the electronic product according to the design specification if the electronic product has the special function.

10. The method according to claim 7, further comprising:
storing the assembly information of the electronic product and the functional BOM of the electronic product into a storage system of the computing device .

11. The method according to claim 7, wherein the assembly information of the electronic product comprises the characteristic data of the electronic components that are recorded in the functional BOM of the electronic product.

12. The method according to claim 7, wherein the characteristic data of the electronic components comprise a name of each electronic component, a serial number of each electronic component, a customer number of each electronic component, and a function description of each electronic component.

13. A non-transitory computer-readable medium having stored thereon instructions that, when executed by at least one processor of a computing device, causes the computing device to perform a method for processing a bill of material (BOM) of an electronic product, the method comprising:
identifying each electronic component of the electronic product according to a function description of the electronic component, and generating an identification code for each of the electronic components;
obtaining characteristic data of all the electronic components from a database that is connected to the computing device, and creating a functional BOM of the electronic components according to the characteristic data of the electronic components;
classifying the electronic components into different groups of the functional BOM according to the identification code of each of the electronic components;
converting a format of the functional BOM to a special file format having a data counting function, and counting a total number of the electronic components in each of the classified groups; and
generating assembly information of the electronic product according to the functional BOM, and displaying the assembly information of the electronic product on a display device that is connected to the computing device.

14. The medium according to claim 13, wherein the method further comprises:
determining whether all the electronic components have been identified by checking whether each of the electronic components has an identification code.

15. The medium according to claim 13, wherein the method further comprises:
determining whether the electronic product has a special function according to a design specification of the electronic product; and
generating the functional BOM of the electronic product according to the design specification if the electronic product has the special function.

16. The medium according to claim 13, wherein the method further comprises:
storing the assembly information of the electronic product and the functional BOM of the electronic product into a storage system of the computing device.

17. The medium according to claim 13, wherein the assembly information of the electronic product comprises the characteristic data of the electronic components that are recorded in the functional BOM of the electronic product.

18. The medium according to claim 13, wherein the characteristic data of the electronic components comprise a name of each electronic component, a serial number of each electronic component, a customer number of each electronic component, and a function description of each electronic component.
